(19) United States
(12) Patent Application Publication
(10) Pub. No.: US 2014/0126993 A1
(43) Pub. Date: May 8, 2014

(54) DEVICE AND A METHOD FOR MEASURING THE TIMES OF PASSAGE OF BLADE TIPS IN A TURBINE ENGINE

(71) Applicant: Andre Leroux, Samois Sur Seine (FR)

(72) Inventor: Andre Leroux, Samois Sur Seine (FR)

(73) Assignee: SNECMA, Paris (FR)

(21) Appl. No.: 14/130,382

(22) PCT Filed: Jun. 27, 2012
(86) PCT No.: PCT/FR2012/051478

§ 371 Date: Dec. 31, 2013

(30) Foreign Application Priority Data
Jul. 1, 2011 (FR) 11 55983

(51) Int. Cl. F02C 7/00

(52) U.S. Cl. CPC F02C 7/00
USPC 415/1; 415/118

(57) ABSTRACT

A device and method to measure times of passage of blade tips in a turbine engine by a capacitive sensor mounted on a casing in register with a path followed by the tips of blades of a compressor wheel of the turbine engine. The sensor includes at least one elongate electrode fastened to an inside face of the casing and oriented obliquely relative to the path of the blade tips.

The present invention relates to a device and a method for measuring the times of passage of blade tips in a stage of a turbine engine such as an airplane turboprop or turbojet.

In known manner, a bypass turbine engine comprises a fan that delivers an air stream that is divided into a primary air stream flowing inside a turbojet via a compressor, a combustion chamber, and a turbine, and a secondary air stream flowing around the turbojet.

The compressor comprises several rows of rotor blades arranged in alternation with rows of stator vanes and surrounded by a casing. In order to avoid air passing over blade tips, which would reduce the efficiency of the turbine engine, a coating of abradable material is carried by the inside surface of the fan casing and arranged in register with the fan blades.

While the turbine engine is in operation, it is important to know the extent to which the rotor blades are deformed. To this end, it is known to mount sensors on the casing, each sensor having a sensing element arranged in register with the blades. The sensors are connected to data processor means. The sensing element of each sensor serves to detect the passage of a blade tip (known as “tip timing”) and it is thus possible by comparing the theoretical times of passage for a blade tip with the times of passage as measured to determine how the blade is deformed, i.e. whether it is deformed in bending, in twisting, . . . , and also to determine the magnitude of the deformation.

Nevertheless, the sensors are incorporated by forming orifices in the casing in register with the blades, thereby weakening the casing and forming cavities in register with the radially outer ends of the blades, thereby generating sound nuisance as a result of the blades going past at high speed.

Another drawback stems from the fact that it is difficult to know accurately the axial positioning of the sensors relative to the blade tips. This difficulty comes from accumulating the manufacturing tolerances for the wheel and for the elements fastening the wheel on its rotor, which is itself positioned axially relative to the casing carrying the sensors. Aerodynamic, thermal, and mechanical stresses on the turbine engine in operation can also influence the axial position of the blade tips relative to the electrodes.

Nevertheless it is essential to know this information in order to be able to deduce the deformation of the blades in operation from their times of passage. Specifically, in twisting mode, for example, which consists in the blade of deforming about its longitudinal axis, a given axial position of the electrode relative to the blade tips can lead to detecting the blade tip when the twisting mode passes through a node (no deformation), whereas for another axial position of the electrode relative to the blades, the blade tip can be detected when the twisting mode is passing through an anti-node (maximum deformation), which in the first configuration leads to the deformation of the blade passing undetected, whereas in the second configuration it is detected. Nevertheless, without accurate prior knowledge of the axial position of the blade tips relative to the electrode, it is impossible to know whether the deformation corresponds to deformation that is near to or far from an axial edge of the blade, which means that it is not possible to know whether the deformation needs to be considered as being small or large.

When the axial positions of the sensors are not known, it is possible to place a plurality of sensors in different axial positions, but that complicates the design of the turbine engine.

Known devices enable the axial positioning of the blades relative to the sensors to be measured. Nevertheless, those devices are found to be difficult to put into practice and they are also not very accurate.

A particular object of the invention is to provide a solution to these problems that is simple, inexpensive and effective.

To this end, the invention provides a turbine engine stage, such as a compression stage, including a capacitive sensor mounted on a casing in register with the path followed by the tips of blades of a rotor wheel in order to measure the times of passage of the blade tips, the stage being characterized in that the sensor comprises at least one elongate electrode fastened on the inside face of the casing and oriented obliquely relative to the path of the blade tips so as to extend along the axis of rotation of the wheel across the paths at least of the leading edges or of the trailing edges of the blades, and in that the downstream end of the electrode is circumferentially offset relative to its upstream end in the same direction as the trailing edges of the blades are offset relative to the leading edges of the blades.

By using a capacitive sensor with an electrode that is elongate and by positioning the elongate electrode across the path at least of the leading edges or of the trailing edges of the blade tips, the invention makes it possible to have information about the times of passage of a predetermined zone of the blades, namely the leading edges or the trailing edges of the blades, and this is true regardless of the axial positioning of the blade tips relative to the sensor.

Thus, it is no longer necessary to know accurately the axial positioning of the sensors relative to the blade tips. Nevertheless, it should be observed that an operator positioning the electrode on the inside face of the casing must ensure that it is properly positioned across the path of at least the leading edges or the trailing edges of the blades at all of the operating speeds of the turbine engine.

According to the invention, the circumferential offset of the downstream end of the electrode relative to its upstream end in the same direction as the offset of the trailing edges of the blades relative to the leading edges of the blades makes it possible to guarantee that only one blade tip at a time is positioned in register with the electrode, i.e. is in alignment with the electrode along a radial direction. Thus, the signals obtained at the output from the sensor relate to one blade tip only, which makes the signals easier to interpret.

Advantageously, the electrode is dimensioned and positioned in such a manner as to extend across the paths of the leading edges and of the trailing edges of the blades, which makes it possible with a single electrode to measure the times of passage of the leading edges and of the trailing edges of the blades.

According to another characteristic of the invention, the electrode extends along an axis forming a nonzero angle with a plane containing the leading edge and the trailing edge of a blade.

Thus, when the electrode extends simultaneously across the leading edges and the trailing edges of the blades, the leading edge is the first to go past the electrode followed by the remainder of the blade tip going past the electrode, with the trailing edge being detected last.

In a particular embodiment of the invention, a second elongate electrode is fastened to the inside face of the casing and oriented in such a manner as to form a nonzero angle with the first electrode. With the help of the times of passage of the leading edge and of the trailing edge of a given blade in register with the first electrode, and with the help of the times of passage of the leading edge and of the trailing edge of this given blade in register with the second electrode, coupled with the speed of rotation of the blades, this configuration makes it possible to know the axial positions of the leading and trailing edges of the blades relative to the casing.

Advantageously, means are provided for determining the profile of the clearance between a blade tip and the casing on the basis of the output signal from the sensor and on the basis of calibration values.

The present invention also relates to a turbine engine such as a turboprop or a turbojet that includes at least one stage as described above.

Advantageously, the sensor(s) is/are covered by an abradable layer carried by the inside face of the casing in register with the blade tips, thus avoiding making through orifices for the sensors as in the prior art, and enabling the capacitive sensors to be protected against moisture.

The invention also provides a method for measuring the times of passage of blade tips in a turbine engine, the method being characterized in that it consists in:
fastening at least one capacitive sensor having an elongate electrode on an inside face of the casing in register with the path of the blade tips of a compressor wheel of the turbine engine, the electrode being oriented obliquely relative to the path of the blade tips so as to extend along the axis of rotation of the wheel across the paths at least of the leading edges or of the trailing edges of the blades, the downstream end of the electrode being offset circumferentially relative to its upstream end in the same direction as the trailing edges of the blades are offset relative to the leading edges of the blades;
measuring the variations in capacitance of the electrode as a function of the time that results from the blade tips passing in register with the electrode; and
deducing therefrom the times of passage of the leading edges and/or of the trailing edges of the blades.

According to another characteristic of the invention, the method consists in measuring the variations in the difference between the times of passage of blades between the leading edges and the trailing edges of the blades over time and in deducing therefrom information about the twisting of the blades about their longitudinal axes.

It is thus possible to deduce the amplitude of blade vibration or the frequency of blade vibration in twisting

In an embodiment of the invention, the method consists in:
fastening two sensors with elongate electrodes of the above-specified type on the inside face of the casing in register with the blades, the two electrodes forming a nonzero angle relative to each other;
measuring the difference of the times of passage in register with the two electrodes of at least one of the leading and trailing edges of a given electrode; and
deducing from the time difference and from the speed of rotation of the blades, the axial position of at least one of the leading and trailing edges of the blades.

Other advantages and characteristics of the invention appear on reading the following description made by way of nonlimiting example with reference to the accompanying drawings, in which:

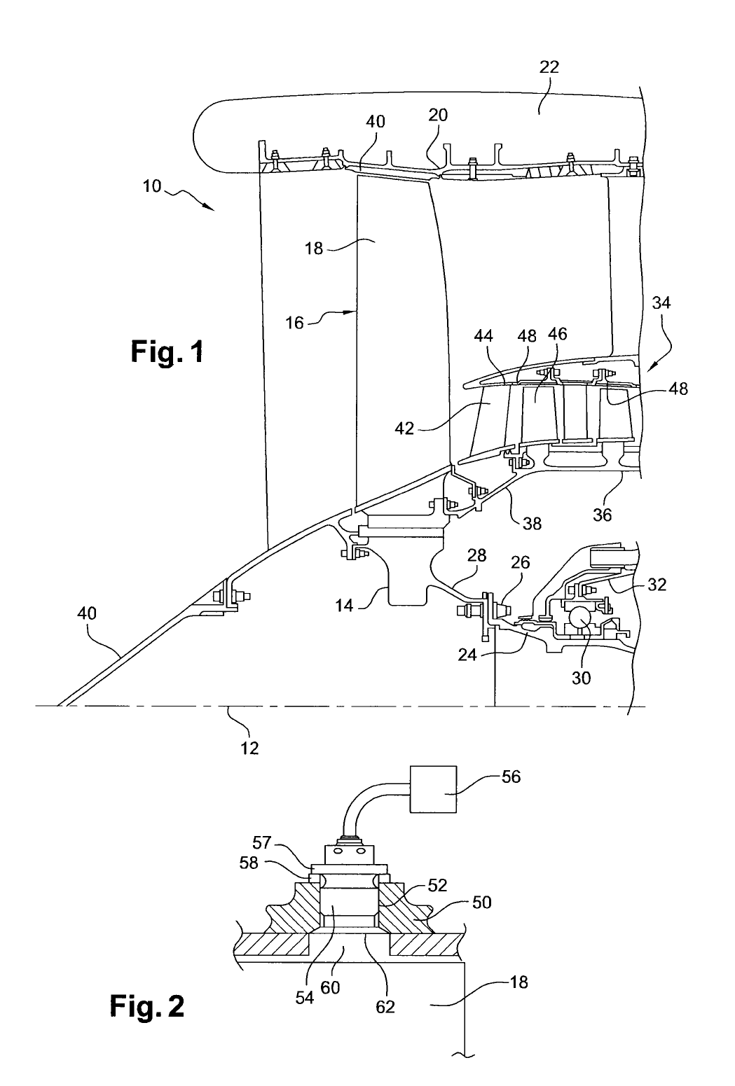

FIG. 1 is a diagrammatic half-view in axial section of a turbojet fan;

FIG. 2 is a diagrammatic view in axial section of a sensor carried by the casing of the FIG. 1 fan, in the prior art;

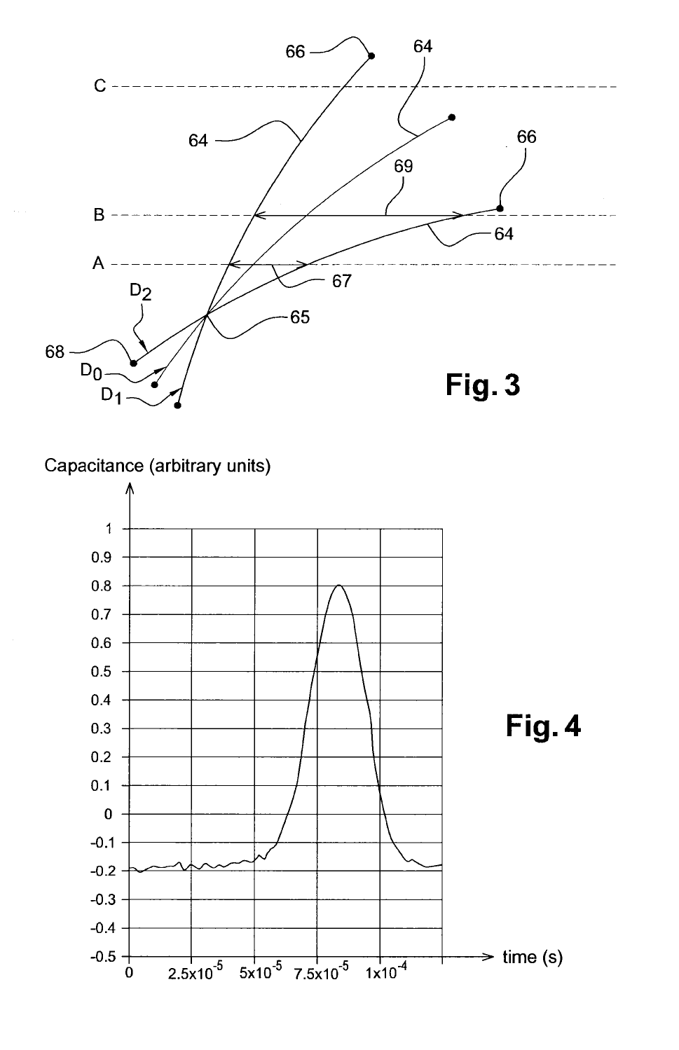

FIG. 3 is a diagrammatic view of deformation of the blade in twisting about a longitudinal axis passing through the root and the tip of the blade;

FIG. 4 is a graph plotting the detection of blade tips going past a sensor in the prior art as a function of time;

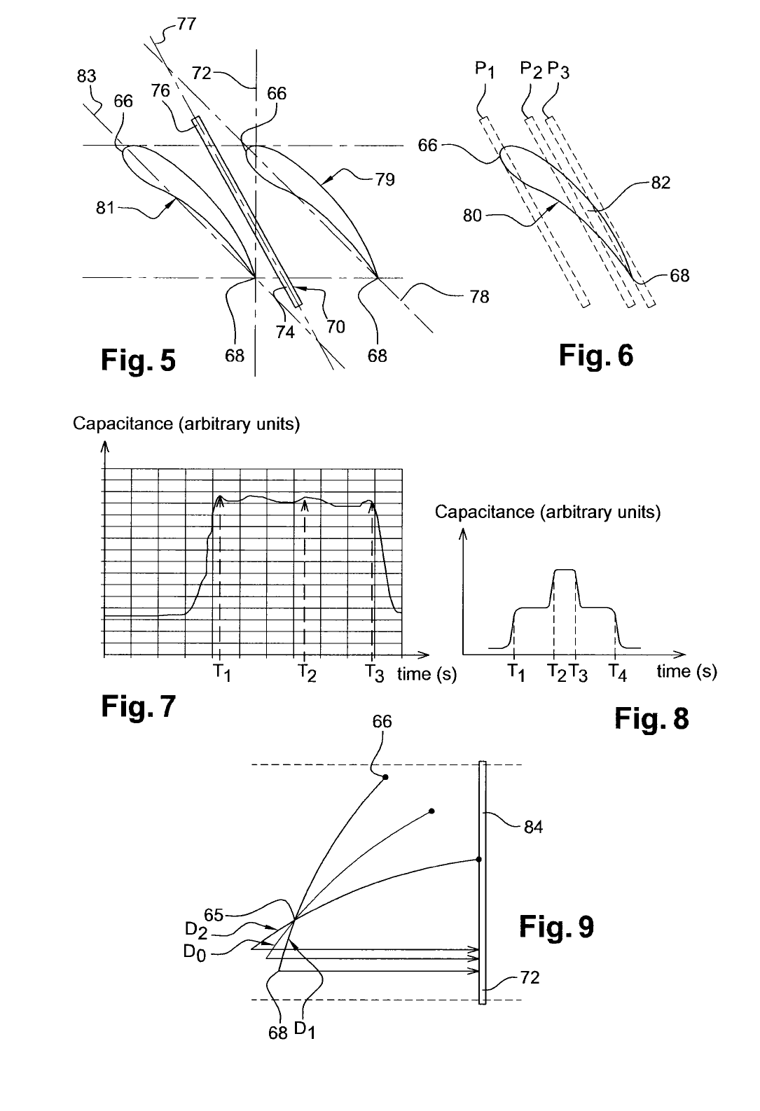

FIG. 5 is a diagrammatic plan view of two consecutive blade tips and of an elongate sensor of the invention;

FIG. 6 is a diagrammatic view of the movement of a blade tip past an elongate electrode of the invention;

FIG. 7 is a graph plotting the variation as a function of time of the capacitance measured by the elongate electrode during the passage of blades past the FIG. 5 electrode;

FIG. 8 is a graph showing the variation of the capacitance in a different arrangement of the elongate electrode relative to the blade tips;

FIG. 9 is a diagrammatic view of deformation of the blade in twisting about a longitudinal axis passing through the root and the tip of the blade, and of an elongate electrode of the invention;

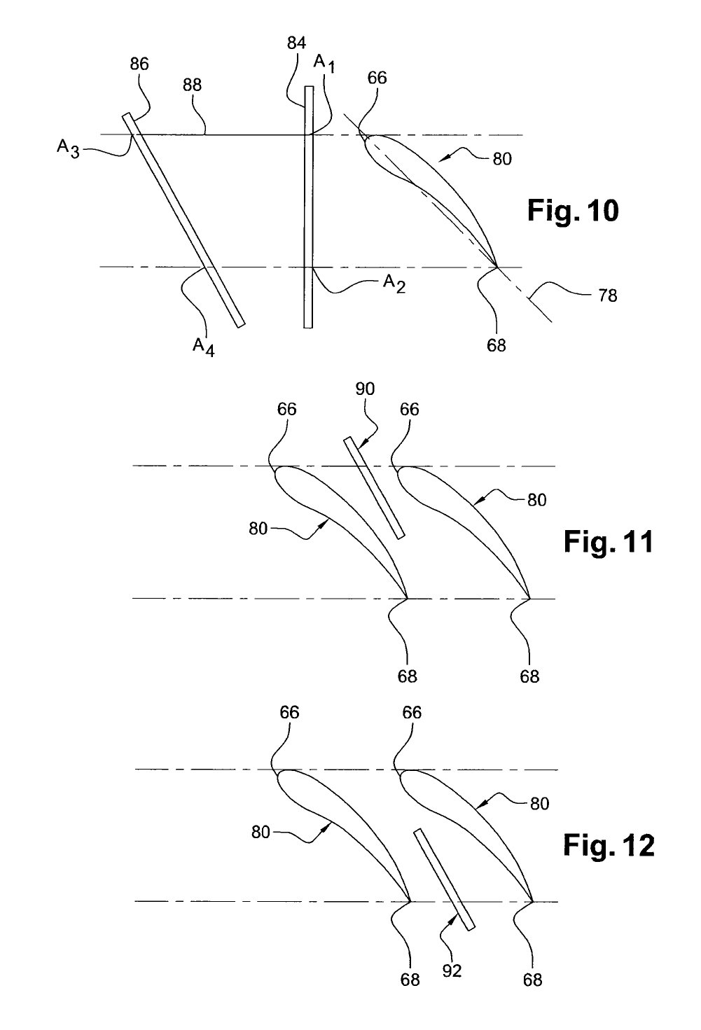

FIG. 10 is a diagrammatic plan view of two elongate electrodes of the invention and of a blade tip; and

FIGS. 11 and 12 are diagrammatic views of variant embodiments of the invention.

Reference is made initially to FIG. 1, which shows a fan 10 of a turbine engine of axis 12, the fan comprising a wheel made up of a disk 14 carrying a plurality of blades 16 at its periphery, the blades having roots engaged in slots in the disk 14 and airfoils 18 extending radially outwards towards a fan casing 20 carrying a nacelle 22 surrounding the blades 16 on the outside. The fan wheel is driven in rotation about the axis 12 of the turbine engine by a shaft 24 fastened by bolts 26 to a frustoconical wall 28 secured to the fan wheel. The shaft 24 is supported and guided by a bearing 30, which is carried by the front end of an annular support 32 fastened downstream to an intermediate casing (not shown) arranged downstream from a low-pressure compressor 34 having its rotor 36 secured to the fan wheel via a connecting wall 38.

On an inside face, the fan casing 20 has a coating of abradable material 40 arranged in register with the fan blades 16 for the purpose of being worn away on contact with the radially outer ends of the blades 16. This layer of abradable material 40 serves to reduce clearance between the tips of the blades 16 and the fan casing 20, and thus to optimize the performance of the turbine engine.

The low-pressure compressor 34 comprises an alternation of stationary vanes 42 carried by an outer casing 44 and of rotary wheels 46 carried by the rotor 36. Each rotor wheel 46 comprises a plurality of blades regularly distributed around the axis 12 of the turbine engine, and it is surrounded on the outside by a layer 48 of abradable material carried by the inside surface of the casing 44 of the low-pressure compressor.

In order to measure the times of passage of the blades and in order to deduce therefrom their deformation in operation, a plurality of sensors are arranged on the casing 20 of the fan 10 (FIG. 2). The casing 20 has bosses 50 formed on its outside surface and circumferentially spaced apart from one another. Each boss 50 includes an orifice 52 opening out to the inside of the casing 20 in the flow passage for the stream of air, and it contains a sensor 54 of substantially cylindrical shape that is connected by a cable to processor means 56. Each sensor 54 includes an annular base 57 at its radially outer end. An annular spacer 58 is interposed between the base 57 and the outside surface of the boss 50. This spacer 58 serves to adjust the extent to which the sensor is inserted inside the orifice. Each sensor 54 is inserted from the outside of the casing to the inside of an orifice 52, and the thickness of the spacer 58 is such that the active face of the sensor is inside of the orifice 52 and set back from the outlet of the orifice into the air flow passage. The layer of abradable material 40 covers the inside surface of the casing with the exception of the outlets of the orifices 52. Cavities 60 are thus formed between the radially outer ends of the blades 18 and the active faces or electrodes 62 of the sensors 54.

As explained above, in order to determine the deformation of the blades in operation, it is necessary to know the axial positioning of the sensors relative to the blade tips.

FIG. 3 is a diagrammatic view of the tip 64 of a blade in a non-deformed position D₀ and in two deformed positions D₁, D₂ in which the blade is twisted about a longitudinal axis 65 extending between its root and its tip. The blade has a leading edge 66 and a trailing edge 68.

Consider three potential axial positions A, B, C for a sensor relative to the blade. In the first position A, when the blade in deformation state D₁ goes past the electrode, the sensor records variation in the capacitance (in arbitrary units, FIG. 4) as a function of time. This curve passes through an aptitude maximum that corresponds to a time representing the time the zone A₁ of the blade tip 64 goes past the electrode.

By using a plurality of electrodes distributed circumferentially around the axis of the casing, it is possible to measure the time of passage of the blade in deformation state D₂.

By comparing the theoretical time of passage of the blade corresponding to no deformation with the times of passage of the blade when the blade is deformed in states D₁ and D₂, it is possible to estimate the deformation of the blade (double headed arrow 67).

When the sensor is axially positioned at B, corresponding to a position closer to the leading edge than the position A, it can be observed that the estimates of the deformation will give a larger deformation value (double headed arrow 69) even through the real deformation is nevertheless identical.

When the sensor is positioned at C, corresponding to a position very close to the leading edge, it can be seen that it is not possible to make an estimate of the deformation of the blade, since the blade goes past a sensor only when the blade is in deformation state D₂.

Thus, it can be seen that for the two positions A, B, it is possible to estimate the deformation, while for the position C it is not possible. Furthermore, in the first two situations A, B, the fact of not knowing the axial positions of the sensors relative to the blades makes it impossible to know whether the measured deformation was obtained at the end of a blade or in an intermediate portion, which means it is not possible to assess the level of the estimated deformation.

The invention thus proposes solving this drawback together with those mentioned above by means of at least one capacitive sensor having an electrode 70 that is rectilinear and fastened to the inside face of the casing.

The electrode 70 extends along the axis of rotation 72 and across the path followed by the blades such that at least one of the leading and trailing edges 66 or 68 of the blades goes past the electrode 70 carried by the casing.

The electrode 70 is dimensioned and positioned on the casing in such a manner that the leading edges or the trailing edges can be detected regardless of the state of deformation of the blade. In practice, in order to guarantee that detection takes place, the sensor must extend far enough upstream or downstream from the leading edge or the trailing edge, respectively, to guarantee that it will be detected by the electrode (see FIG. 9, which shows a plurality of deformation states of a blade).

In a first embodiment of the invention as shown in FIG. 5, the electrode 70 extends both across the paths of the leading edges and across the paths of the trailing edges of the blades. With such an arrangement, the electrode can detect both the passage of a leading edge 66 and of a trailing edge 68 of a blade.

The downstream end 74 of the electrode 70 is circumferentially offset relative to its upstream end 76 in the same direction as the trailing edges 68 of the blades are offset relative to the leading edges 66 of the blades.

Preferably, as shown in FIG. 5, when the rectilinear electrode 70 is positioned between two adjacent blade tips 79 and 81, the axis 77 of the rectilinear electrode 70 forms a nonzero angle with the planes 78 and 83 containing the leading and trailing edges 66 and 68 of each of the blades 79 and 81. The axis 77 intercepts the plane 78 upstream from the leading edge 66 of the blade 79, and it intercepts the plane 83 downstream from the trailing edge 68 of the blade 81. In this way, it is possible to guarantee that the leading edge 66 is the first portion to go past the rectilinear electrode 70, followed by the remainder of the blade tip, all way to the trailing edge 68.

FIG. 6 shows three positions P₁, P₂, and P₃ of the rectilinear electrode relative to a blade tip 80. To clarify the figure, a single electrode 70 is shown in three positions, even though it is the blade that moves relative to the electrode 70.

The first position P₁ of the electrode corresponds to the position in which the leading edge 66 of the blade is positioned in register with the rectilinear electrode 70, which corresponds to the instant T₁ in FIG. 7. The second position P₂ of the electrode corresponds to the position in which the middle portion 82 of the blade tip 80 is positioned in register with the electrode 70, which corresponds to the instant T₂ in FIG. 7. Finally, the third position P₃ of the electrode 70 corresponds to the position in which the trailing edge 68 of the blade is positioned in register with the rectilinear electrode 70, which corresponds to the instant T₃ in FIG. 7

Thus, for each blade that passes in register with a rectilinear electrode 70 positioned across the paths of the leading edges and of the trailing edges and extending in part along the axis of rotation, an output signal is obtained from the sensor that is of the type shown in FIG. 7, in which the first maximum obtained at the instant T₁ corresponds to detecting the leading edge 66 of the blade, and in which the last maximum obtained at the instant T₃ corresponds to detecting the trailing edge 68 of the blade.

Between the instants T₁ and T₃, variation in the capacitance can be seen that is representative of variation in the clearance between the blade tip 80 and the electrode 70 going from the leading edge 66 to the trailing edge 68.

Before putting the electrode 70 into place on the casing, the amplitude of the capacitance is calibrated as a function of the distance between the blade tip 80 and the electrode 70 and as a function of the position of the electrode 70 in register with the blade tip 80. To do this, the leading edge 66 of the blade 80 is positioned in register with the electrode 70 and a plurality of measurements are made of the capacitance of the electrode 70 while moving the blade tip 80 towards the electrode 70. This operation is repeated for a plurality of successive positions Pᵢ of the electrode 70 in register with the blade tip 80 up to the position P₃ of the electrode 70 in register with the trailing age 68 of the blade 80. With the help of these various measurements, a curve is obtained for calibrating the amplitude of the capacitance as a function of the distance of the electrode 70 in register with the blade tip 80 for each position of the blade tip 80 relative to the electrode 70, thus making it possible to deduce therefrom variations in clearance along the tip of a blade 80.

It should be observed that this calibration at a plurality of positions of the blade tip 80 in register with the electrode 70 is necessary because of the varying surface area of the blade tip 80 positioned in register with the electrode 70. This is shown diagrammatically in

FIG. 6 where the surface area S₁ detected by the electrode 70 in position P₁ is smaller than the surface area S₂ detected by the electrode 70 in position P₂.

Knowing the clearance jᵢ at the blade tip for each instant Tᵢ between the instants T₁ and T₃, makes it possible by calculating 100×(Tᵢ−T₁)/(T₃−T₁) to obtain the position of the clearance jᵢ along the blade tip as a percentage of the distance between the leading edge and the trailing edge, while being insensitive to the speed of rotation of the blades.

Thus, unlike the prior art, where it is possible only to determine the clearance of each portion of the blade tip passing in register with the electrode, it is possible to know which zone of the blade tip 80 is the closest to the casing and the most likely to touch it. The invention thus makes it possible to determine the clearance jᵢ between the tip of a blade and the casing going from the upstream end of the blade tip 80 adjacent to the leading edge 66 all the way to the downstream end of the blade tip 80 adjacent to the trailing edge 68.

In the embodiment of FIG. 5, it can be seen that the electrode 70 is inclined relative to the axis 72 so that the tip 80 of only a single blade can be positioned in register with the electrode at any one instant. This type of configuration can simplify interpreting the electric signals obtained at the output from the sensor.

Nevertheless, for an electrode oriented along the axis of rotation 72 of the blades, the leading edge 66 of a first blade and the trailing edge 68 of an adjacent second blade could be detected simultaneously by the electrode, thereby giving rise to an increase in the capacitance measured by the sensor. This would produce a curve of the type shown in FIG. 8 and having three levels, namely a first level between T₁ and T₂ corresponding to a first blade passing in register with the electrode, a second level between T₂ and T₃ corresponding to simultaneously detecting the tip of the first blade and the tip of the second blade, and a third level between T₃ and T₄ corresponding to detecting the tip of the second blade on its own.

With such a configuration, it is entirely possible to obtain the times of passage of the leading edges 66 and of the trailing edges 68 of each of the blades. Nevertheless, it is more difficult to evaluate the clearance at the blade tips because of the adding of the capacitances involving two blades in register with the electrode, which means that it is not possible to distinguish which of the two portions of the blades that are detected at the same instant is the closer to the electrode or the further away therefrom.

FIG. 9 is a view similar to FIG. 3 showing the prior art and in which there has been added a rectilinear electrode 84 that is oriented along the axis of rotation 72 of the blades. When the blade is in its non-deformed state D₀, it passes in register with the electrode 84 between instants T₁ and T₂. In deformation state D₁, it passes in register with the electrode between instants T₁′ and T₂′. Finally, in deformation state D₂, it passes in register with the electrode between instants T₁″ and T₂″. The times T₁, T₁′, and T₁″ correspond to the times of passage of the leading edge 66 of the blade, and the times T₂, T₂′, and T₂″ correspond to the times of passage of the trailing edge 68 of the blade.

The variation between the times T₁, T₁′, and T₁″ provides information about the vibratory activity of the blade at its leading edge 66, whereas the variation between the times T₂, T₂′, and T₂″ provides information about the vibratory activity of the blade at its trailing edge 68. The variation between the time differences T₁−T₂, T₁′−T₂′, and T₁″−T₂″ provides information about the twisting of the blade about its longitudinal axis 65.

Thus, in the invention, it is possible to access information about the times of passage of the leading edges 66 and of the trailing edges 68 of the blades without knowing beforehand the axial position of the electrode 84 relative to the blades.

In a particular embodiment of the invention, a second rectilinear electrode 86 is fastened on the inside face of the casing and oriented in such a manner as to form a nonzero angle with the first electrode 84 and with a plane 78 containing the leading edge and the trailing edge of the blade (FIG. 10).

When the tip of the blade 80 passes in register with the first electrode 84, it records at A₁ a time of passage T₁ of the leading edge 66, and at A₂ a time of passage T₂ of the trailing edge 68. When the tip of the blade 80 passes in register with the first electrode 86, it records at A₃ a time of passage T₃ of the leading edge 66, and at A₄ a time of passage T₄ of the trailing edge 68.

The time difference T₃−T₁ multiplied by the speed of rotation of the blades (in rad·s⁻¹) serves to provide an estimate of the arcuate distance (in radians) traveled by the leading edge 66 between the points A₁ and A₃. This arcuate distance corresponds to a single arc 88 extending in a circumferential direction and intersecting the two electrodes 84 and 86, thus making it possible to obtain the real positions of the points A₁ and A₃ on the electrodes, and thus the axial positioning of the leading edges 66 relative to the casing. In similar manner, it is possible to obtain the axial positioning of the trailing edges 68 of the blades by using the time difference T₄−T₂.

Nevertheless, calculating in this way assumes that the deformation amplitude of the blade is negligible compared with the arcuate distance traveled by the blade, and in practice this is generally true. In a configuration where the deformation of the blade is not negligible compared with the arcuate distance traveled by the blade, it is possible to perform digital processing such as, for example, averaging the times T₃−T₁ and T₄−T₂ over several revolutions.

When it is desired to obtain information relating solely to the leading edges 66 or solely to the trailing edges 68 of the blades, it is possible to position and dimension the electrodes 90, 92 in such a manner that they extend respectively across only the leading edges 66 (FIG. 11) or only the trailing edges 68 (FIG. 12) of the blades.

In the description made with reference to the drawings, the electrodes 70, 84, 86, 90, and 82 are rectilinear in shape. Nevertheless it can be understood that the electrodes could have a shape that is elongate without necessarily being rectilinear. Under such circumstances, the electrodes may have a curved shape adapted so as to extend along the axis of rotation 72 of the wheel across the paths at least of the leading edges 66 or of the trailing edges 68 of the blades. Other electrode shapes are also possible, e.g. such as a zigzag shape comprising a succession of curved portions or indeed a succession of rectilinear portions arranged end to end.

Although the invention is described above with reference to a turbine engine, it will nevertheless be understood that the invention is applicable to any subassembly of a machine comprising a casing and a bladed wheel rotatable inside the casing, and in which the casing carries at least one electrode that is arranged and dimensioned as described above.

In particular, the invention is applicable to a turbine engine fan as described above and as shown in FIG. 1.

1-10. (canceled)

11. A turbine engine stage, or a compression stage, comprising:
a capacitive sensor mounted on a casing in register with a path followed by tips of blades of a rotor wheel to measure times of passage of the blade tips,
wherein the sensor comprises at least one elongate electrode fastened on an inside face of the casing and oriented obliquely relative to the path of the blade tips to extend along an axis of rotation of a wheel across paths at least of leading edges or of trailing edges of the blades, and
wherein a downstream end of the electrode is circumferentially offset relative to its upstream end in a same direction as the trailing edges of the blades are offset relative to the leading edges of the blades.

12. A stage according to claim 11, wherein the electrode is dimensioned and positioned to extend across the paths of the leading edges and of the trailing edges of the blades.

13. A stage according to claim 11, wherein the electrode extends along an axis forming a nonzero angle with a plane containing the leading edge and the trailing edge of a blade.

14. A stage according to claim 11, further comprising a second elongate electrode fastened to the inside face of the casing and oriented to form a nonzero angle with the first electrode.

15. A stage according to claim 11, further comprising means for determining a profile of clearance between a blade tip and the casing on the basis of an output signal from the sensor and on the basis of calibration values.

16. A turbine engine, or an airplane turboprop, or a turbojet, comprising at least one stage according to claim 11.

17. A turbine engine according to claim 16, wherein the sensor is covered by an abradable layer carried by the inside face of the casing in register with the blade tips.

18. A method for measuring times of passage of blade tips in a turbine engine, the method comprising:
fastening at least one capacitive sensor having an elongate electrode on an inside face of a casing in register with a path of blade tips of a compressor wheel of the turbine engine, the electrode being oriented obliquely relative to the path of the blade tips to extend along an axis of rotation of the wheel across paths at least of leading edges or of trailing edges of the blades, a downstream end of the electrode being offset circumferentially relative to its upstream end in a same direction as the trailing edges of the blades are offset relative to the leading edges of the blades;
measuring variations in capacitance of the electrode as a function of a time that results from the blade tips passing in register with the electrode; and
deducing from the measured variations in capacitance times of passage of the leading edges and/or of the trailing edges of the blades.

19. A method according to claim 18, further comprising measuring variations in difference between the times of passage of blades between the leading edges and the trailing edges of the blades over time and deducing therefrom information about twisting of the blades about their longitudinal axes.

20. A method according to claim 18, further comprising:
fastening two of the sensors with elongate electrodes on the inside face of the casing in register with the blades, the two electrodes forming a nonzero angle relative to each other;
measuring the difference of the times of passage in register with the two electrodes of at least one of the leading and trailing edges of a given blade; and
deducing from the time difference and from a speed of rotation of the blades, an axial position of at least one of the leading and trailing edges of the blades relative to the electrode.
